(19) United States
(12) Patent Application Publication
(10) Pub. No.: US 2021/0127267 A1
(43) Pub. Date: Apr. 29, 2021

(54) System and Method for Applying Dynamic Access Policies and Data Management for Network Operations Centers

(71) Applicant: The United States of America as represented by the Secretary of the Navy, San Diego, CA (US)

(72) Inventor: Raheleh B. Dilmaghani, San Diego, CA (US)

(21) Appl. No.: 16/660,920

(22) Filed: Oct. 23, 2019

(51) Int. Cl. H04W 12/08; H04L 29/06; H04L 12/46

(52) U.S. Cl. CPC H04W 12/08; H04L 12/4633; H04L 63/20

(57) ABSTRACT

A status of connectivity in a hybrid heterogeneous network of network nodes is determined, at a controller node in the network. Access policies and data management in the hybrid heterogeneous network are adaptively controlled by determining a revision to a current packet routing flow controlled by a first one of the network nodes that is different from the controller node, based on a determination that the status of connectivity indicates a quality level value that is less than a predetermined threshold value, and transmitting the determined revision to the first one of the network nodes. The hybrid heterogeneous network includes a Software Defined Network (SDN) router and a non-SDN router, wherein a packet is encapsulated for routing through a virtual tunnel between two end point network nodes that are configured to support SDN.

### FEDERALLY-SPONSORED RESEARCH AND DEVELOPMENT

The United States Government has ownership rights in this invention. Licensing inquiries may be directed to Office of Research and Technical Applications, Naval Information Warfare Center, Pacific, Code 72120, San Diego, Calif., 92152; telephone (619)553-5118; email: ssc_pac_t2@navy.mil. Reference Navy Case No. 103,959.

### BACKGROUND

Routers of packets among nodes is a component of networks, the operation of which may be complicated by the environments characterized by low bandwidth, large latency, high energy consumption, and node mobility. Nodes need to be able to relay information throughout the network in an efficient manner and adapt autonomously to topology, policy, or job changes. Issues may be caused by intermittent networks whereby nodes may attempt to forward packets to a destination node that is currently unreachable. Further, network management may be complex, including management of dynamic access control lists and network device systems on a per box basis. Human management is not only slow, but prone to introducing error.

### BRIEF DESCRIPTION OF THE DRAWINGS

FIG. 1 is a block diagram of an example system having a distributed network architecture.

FIG. 2 is a block diagram of an example node in the distributed network architecture shown in FIG. 1.

FIG. 3 illustrates an example network architecture.

FIG. 4 illustrates an example Software Defined Network (SDN) architecture.

FIG. 5 is a flowchart illustrating operations of a system for adaptively controlling access policies and data management in a hybrid heterogeneous network of network nodes.

FIG. 6 is a flowchart illustrating operations of a system for dynamically controlling access policies and data management in a hybrid heterogeneous network of network nodes.

### DETAILED DESCRIPTION

Issues may be caused by intermittent networks whereby nodes attempt to forward packets to a destination node that is currently unreachable. Further, network management may be complex, including management of dynamic access control lists and network device systems on a per box basis. Human management is not only slow, but prone to introducing error.

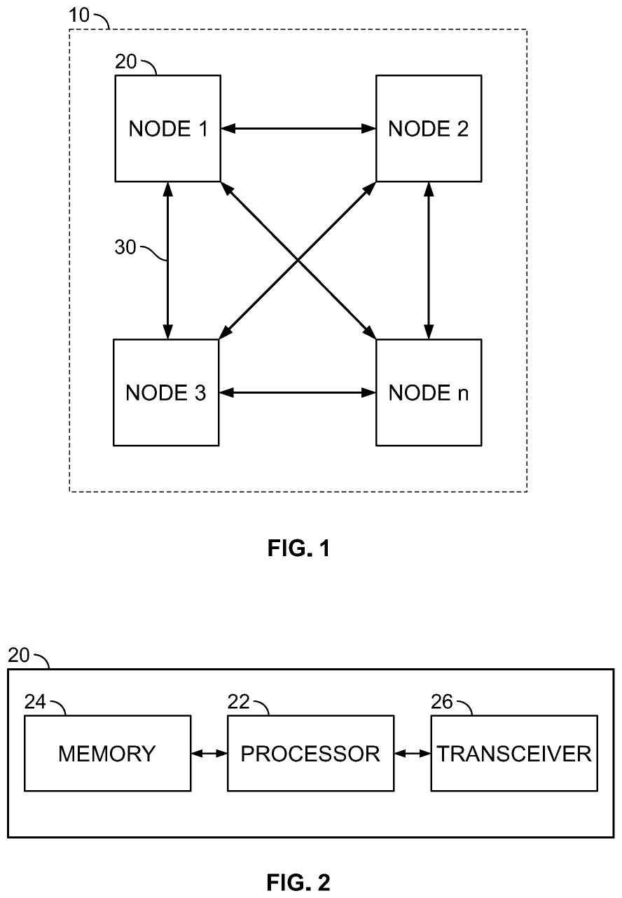

FIG. 1 is a block diagram of an example system 10 having a distributed network architecture that may be used to implement methods discussed herein. System 10 may include a plurality of nodes 20 that are each configured to send signals 30 to each of the other nodes 20 and receive signals 30 from each of the other nodes 20. Nodes 20 may be organized in any type of distributed network system. In some embodiments, nodes 20 are fixed in their location within the network. In some embodiments, nodes 20 are mobile and are able to move about within the network. In some embodiments, system 10 may include both fixed and mobile nodes. In some embodiments, nodes 20 comprise sensors that may be used to detect objects within an environment. It is to be understood that this is a simplistic diagram of a network,

FIG. 2 is a block diagram of an example of a node 20. As shown, node 20 includes a processor 22 operatively connected to a memory unit 24 and a transceiver 26. In some embodiments, processor 22 is a general purpose processor. In some embodiments, processor 22 is a processor that is specifically programmed to contain instructions therein, readable by the processor, that allow the processor to send/receive information from memory unit 24 and transceiver 26, as well as to cause transceiver 26 to send/receive signals in accordance with embodiments discussed herein. Further, depending on the particular application of the node, i.e., a sensor, node 20 may include more components therein to allow the node to perform functions required by the specific application.

Example methods and systems discussed herein address the problem of dynamic access control list and network device system on a per box basis for networks. For example, networks that include mobile network nodes may be complex to manage, and costly to maintain and operate. Many system issues may occur due to human error. Discussed herein is an example hybrid architecture for a network where the control and management is accomplished via a logically centralized, physically distributed controller. Example methods and systems discussed herein may make a recommendation on the application and services that can be run over this paradigm instead of a traditional IP network. Currently, networks may take time to adapt to a current network condition or access policies, and changes may need to be performed per network device. Some advantages of this example architecture may include dynamic Quality of Service (QoS), load balancing, firewall, and use of multi paths, which may save significant system effort per device, thus providing scalability and agility, concerns, or challenges.

Example methods discussed herein may use a logically centralized, physically distributed controller to provide dynamic intelligent access control policies at the edge of a network and provide automation for a programmable network.

SDN technology has been used in research and in industry, with a concept of the separation of a data plane and a control plane. In a conventional Internet Protocol (IP) network, system and access policies may be provided on a box or device basis that may be prone to error and may be time consuming. In SDN, a central controller may adapt to new conditions and apply policies accordingly, thus providing consistency and fast deployment.

For example, deploying SDN at a Network Operations Center (NOC) may enable the data center to transfer access policies consistently and quickly in the network and dynamically adapt to the changes in the network or access policies.

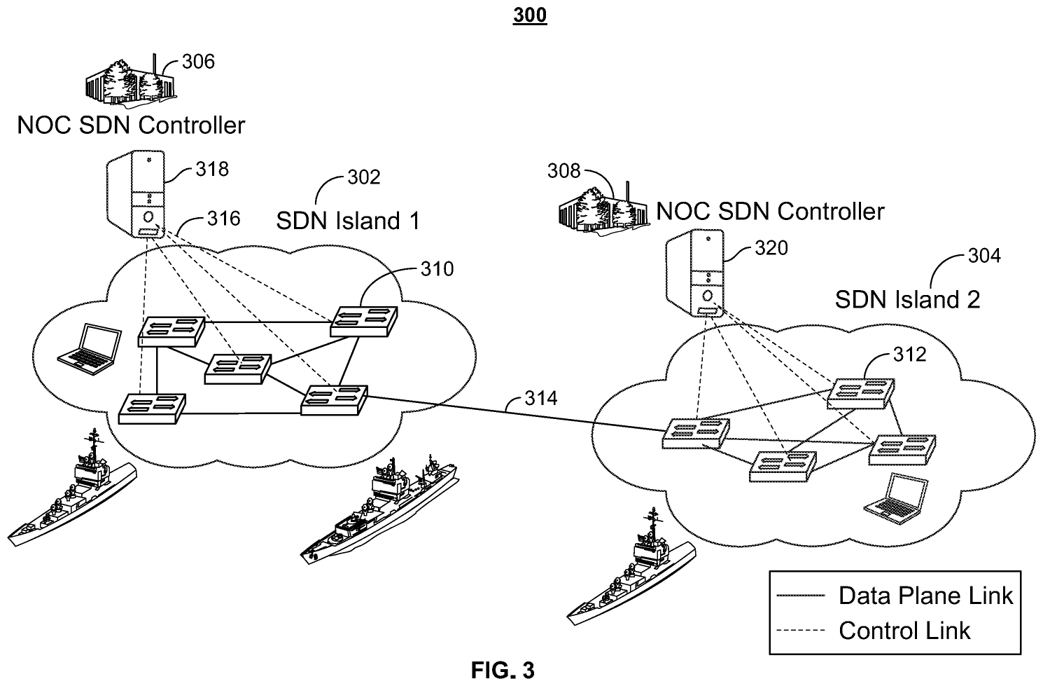

FIG. 3 depicts an illustration of an example network deployment for example methods discussed herein. As shown in FIG. 3, a system 300 may include two SDN domains 302, 304, and two NOCs 306, 308. As discussed herein, an SDN domain may include a region wherein a mobile network node may be able to communicate with a closest NOC, or data center. SDN domains 302, 304 may include switches 310, 312 that understand an implementation of SDN communication protocol between a data plane and a control plane. For example, link 314 illustrates a data plane link (shown with solid line in FIG. 3) and link 316 illustrates a control plane link (shown with dashed line in FIG. 3). The switches 310, 312 may be designed such that the forwarding intelligence is received from a NOC SDN controller 318, 320 and the switches 310, 312 may simply act as forwarding devices. The architecture may be expanded to include hybrid routers or switches that understand both an implementation of an SDN communication protocol and legacy routing protocols. For example, some routers may have SDN capability, and some may not. Software may detect network changes and may adapt network systems, depending on current needs and policies. For example, various switches and routers in networks may be provided by different hardware vendors. A goal of example methods discussed herein is to automate system and network management to lower the cost and error in adapting to job, network, or policy changes in a Disconnected, Intermittent, Limited (DIL) bandwidth environment and to provide interoperability.

With SDN, the network may be programmable and may adapt to dynamic changes quickly throughout the network. Email, File sharing, or collaboration, chat, intelligence and tactical applications are a few examples of applications that may be running over a network. Example methods discussed herein may support policy rules, file sharing and data replications consistently throughout the network.

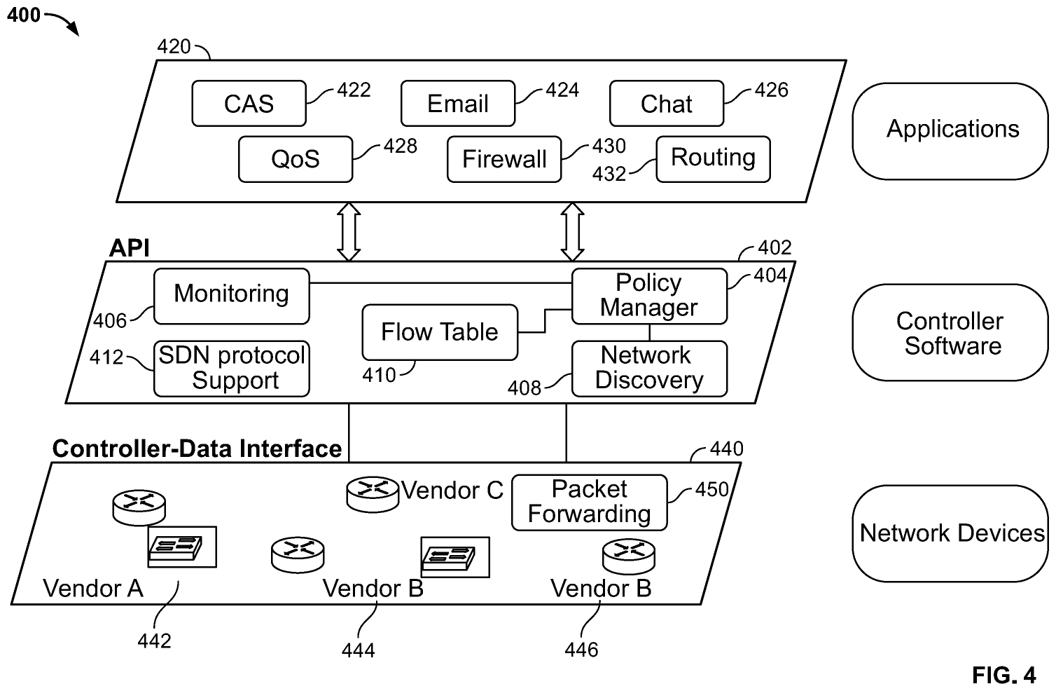

FIG. 4 illustrates an example SDN architecture 400 that may be used for example methods discussed herein. For example, when the architecture of FIG. 4 is applied to a NOC, compared to a conventional IP network, the network management and routing decision may be dynamically adapted to a current network condition and current policies. As shown in FIG. 4, a controller 402 may include multiple software modules. For example, a policy manager module 404 may receive inputs from a monitoring module 406 and a network discovery module 408 and may update a flow table 410 accordingly. An SDN protocol support module 412 is also included in controller 402. Once policy manager module 404 completes its processing, it updates forwarding rules at flow table 408 and the rest of the task is handled by an application layer 420. Thus, controller 402 (middle layer) software may provide dynamic policy access management.

As shown in FIG. 4, application layer 420 includes collaboration module 422, email module 424, chat module 426, QoS module 428, firewall module 430, and routing module 432. Routing module 432 may house optimization functions as well. The programmability and automated resystem may diminish vulnerability to human error.

As shown in FIG. 4, a network device layer 440 may include devices from various vendors (e.g., Vendor A devices 442, Vendor B devices 444, and Vendor C devices 446). As shown in FIG. 4, packet forwarding 450 is accomplished at the network device layer 440.

Example methods and systems discussed herein may allow access policies and device system, routers and switches, to be accomplished via a logically centralized controller, thus providing faster response to dynamic changes in the network environment or access policy rules and providing consistency throughout the network deployment. Example methods and systems discussed herein may conserve time and reduce the possibility of human error by automating system from a logically centralized controller, instead of an individual per box system. This design may thus provide scalability, agility, and programmable network management.

An example method may use tunneling for overlay network management. Another example method may create policy rules and optimize data copies and storage.

Example methods and systems discussed herein may create and update access policies and replicate based on the following:
(1) Access frequencies;
(2) Target location for new rules, intra or inter domain;
(3) Rules distribution;
(4) Inputs from other controllers; and/or
(5) Job requirements.

With regard to use of SDN, two use cases are discussed below, the first for load balancing, and the second for Quality of Service (QoS).

A first use case of SDN, for load balancing, is discussed in Dilmaghani et al., “Evaluation of OpenFlow load balancing for Navy,” 2015 IEEE Military Communications Conference (MILCOM 2015 Track 2), 2015, (“first paper” hereafter).

As discussed in the first paper, load balancing may be used in complex networks to provide reliable performance by ensuring the system is not overloaded and by providing high resource utilization. Load balancing may aid in the stability of a network that includes mobile nodes, in a distributed environment. For example, a network may be highly dynamic due to job requirements, policies, or environmental conditions. There may be insufficient bandwidth for data-intensive operations. Additional challenges of such environments may include limited bandwidth and intermittent connectivity caused by situational conditions. The first paper presents an approach to create a benchmark to evaluate load balancing with an OPENFLOW protocol of SDN technology for a particular scenario. Results discussed in the first paper indicate that SDN technology may provide agility and flexibility to configure and manage the network.

Open Flow is the Open Networking Foundation's (ONF) standard on control protocol of Software-Defined Networking (SDN). SDN makes a network programmable by separating the data and the control plane where the data plane is responsible in forwarding the traffic, and the control plane determines destinations for forwarding the data. SDN may rely on switches that may be programmed through an SDN controller using a control protocol.

Programmable networks may mitigate challenges facing the network in providing an infrastructure to keep pace with expanding application demands and to minimize cost, complexity, and labor needs.

OPENFLOW is a communication protocol that enables an SDN controller to directly communicate with the forwarding plane of network devices including switches and routers. A new packet of a flow is forwarded to the controller by the switch to determine where to route the new packet. A command is translated into low-level instructions for the data plane and appears as a flow entry.

OPENFLOW runs over Transmission Control Protocol (TCP) and is a low-level programming language. An example OPENFLOW packet format is shown below in Table 1.

TABLE 1

Ethernet Header
IP Header (20B)
TCP Header (20B)
Version (1B) and Type (1B) and Length (2B)
Transaction ID (4B)
Type-specific information

The bottom three rows of Table 1 above relate to an OPENFLOW packet format.

An example flow table is shown in Table 2 below.

TABLE 2

| | | | | | |
|---|---|---|---|---|---|
| Match fields | Priority | Counters | Meter bands | Timeouts | Cookies |

An OPENFLOW Meter table includes one or more meter bands which include information on traffic types, rates, actions (e.g., type 1, kb/s, drop, or forward). The bands define the behavior of the meters on packets for various range rates.

In accordance with example methods discussed herein, in a hybrid network (e.g., a network that includes both SDN and common routers), packets may be encapsulated for routing to connect two domains. A virtual tunnel may be established between two end points which understand SDN. The interim routers (between the two end points) do not need to understand the details; they can forward to the next available hop based on a destination's Internet Protocol (IP) address. Tunneling may add additional bits to the packet header, with an expectation of minimal impact on latency and throughput.

For simplicity of management:
(1) Tunneling may be automatically created at system time and in response to a new network or policy condition
(2) Tunneling may be assigned automatically based on predetermined criteria
(3) Tunneling may be defined ad-hoc by management

In accordance with example methods discussed herein, Tables 3 and 4 below illustrate example flow tables that may be located on an SDN node. As shown, Table 3 illustrates table values for a switch SW6. For example, a first rule specifies that a packet having a destination IP address of 10.0.0.6 will be sent out on a port specified by “outportl” (e.g., “outport” specifies on which port to send out the packet). A second rule specifies that a packet having a source IP address of 10.0.0.* and a destination IP address of 8.8.8.8 will be dropped.

TABLE 3
SW6

| Rule | TCP/ | | | | | | |
|---|---|---|---|---|---|---|---|
| # | UDP | src_ip | src_port | dest_ip | dest_port | tos | action |
| 1 | * | * | * | 10.0.0.6 | * | * | outport1 |
| 2 | * | 10.0.0.* | * | 8.8.8.8 | * | | drop |
| 3 | * | 10.0.0.2 | * | * | * | | Outport: |
| | | | | | | | y |
| 4 | * | 10.0.0.* | * | * | * | | drop |

TABLE 4
SW4

| Rule | TCP/ | | | | | | |
|---|---|---|---|---|---|---|---|
| # | UDP | src_ip | src_port | dest_ip | dest_port | tos | action |
| 1 | * | * | * | 10.0.0.4 | * | * | outport1 |
| 2 | * | * | * | * | * | 26 | outport2: |
| | | | | | | | que7 |
| 3 | * | * | * | * | * | 18 | outport2: |
| | | | | | | | que8 |
| 4 | * | * | * | * | * | 10 | drop |

As shown, Table 4 illustrates table values for a switch SW4. For example, a first rule for SW4 specifies that a packet having a destination IP address of 10.0.0.4 will be sent out on a port specified by “outportl.”

In accordance with example methods discussed herein, an implementation may be achieved using the following steps:
(1) Create network topology for mobile and fixed nodes;
(2) Configure switches, queues, links types, bandwidth, etc.;
(3) Configure controller;
(4) Identify which switches talk to which controllers;
(5) Specify controller's role;
(6) Set up queues and QoS;
(7) Add flow table entries;
(8) Check flow table entries;
(9) Configure OPENFLOW implementation of the protocol (e.g., Floodlight or open Daylight) module;
(10) Add delays to interfaces or remove them;
(11) Modify flow table entries;
(12) Develop conditions for rules update automation;
(13) Complete modular design and required interfaces to communicate; and/or
(14) Run, test, debug.

Steps discussed above are not intended to be performed in any particular order, nor are all steps needed to be performed.

Many environments may include different entities communicating over multiple available network technologies. However, as the environmental conditions or job needs change, link availability, bandwidth or access policies may need to be adapted accordingly. For example, the members of a group may change, which may impact the routing and services in the network. In real-life scenarios, a network engineer may travel to an off-site location just to fix a system of a box, which incurs cost.

It is desirable to provide a design and fielding of an agile and secure network. The ability to send correct information to the correct entities at the correct time over a common infrastructure may be highly desirable. For example, conventional network infrastructure may provide security by static physically separated networks. However, use of statically or physically separated networks may place a heavy burden on the infrastructure by utilizing redundant, often identical hardware. Additionally, this may burden network system. Due to limitations in size, weight and power in mobile platforms, operational capabilities may be compromised. Achieving security via physically separated networks may also reduce network agility. Considering multiple domains of security may exacerbate these issues. With automated system, troubleshooting may be reduced by removing possibilities of human error. A software approach may lend itself to such environments, as it may provide dynamic services and updates to the routing remotely rather than individual hardware.

Considering an example operation's need for continuous and reliable service, SDN may improve dynamic network management and security with the central controller with the high-level view of the network. Policy rules may easily and quickly be modified from a controller with a central view, mitigating dynamic traffic and bandwidth management by updating flow control rules. However, a single controller may be subject to a single point of failure. A centralized management miles away from users in an operational scenario may be challenging. For example, it may be desirable for the controller to be highly available and secure to ensure continuous support for network management. Logging of all traffic going through and individual filtering technologies may be needed.

In an one example environment, for example, in order for a first network node to communicate with a second network node, the communication may travel over satellite to a first location, to a NOC, and then from the first location to the second network node. For example, Floodlight may be utilized as an OPENFLOW protocol for communications between controllers and switches.

For example, a network topology may include five Wide Area Network (WAN) switches, three mobile networks nodes and two data centers, in which large volumes of data and voice may be being transferred over WAN links. The WAN switches may be inter-connected to each other. There may be more than one satellite connection available to a particular network node at a point of time. In this scenario, each link may have multiple queues to transmit data traffic. Each queue is configured to handle data traffic for a given bandwidth. The first paper example assumes three types of service requirements for three different types of data. For this example, packets are generated with a Differentiated Services Code Point (DSCP) to distinguish different types of traffic to provide QoS. The corresponding Type of Service (ToS) is observed and verified when capturing the packet. The example of the first paper includes three types of traffic, from high priority (type 1) to low priority (type 3). The controller injects flow entries to each WAN switch so that QoS for the traffic is provided by forwarding the traffic to the appropriate WAN switch. The controller monitors the WAN switches and links for any topology change in the network. For this example, the controller is programmed such that it can update flow entries depending on the environment or job condition.

As an example scenario, an operator at a mobile network node may receive a new job package that may involve changes in system and security access of the network. The data may need to be sent to participants in the job. The data may travel from a first network node to a first location, going through one or more NOCs before reaching the destination. As environmental conditions change, there may be a connectivity disruption on available paths. Similarly, access policy rules may change based on job requirements, which may lead to a network node or a route being excluded from the communication path or added, which in turn may be translated into updates to flow rules. Depending on conditions, the link availability or available bandwidth changes and load balancing service may need to adapt to the new conditions rapidly to ensure reliable and agile performance. An SDN controller and programmable interface may provide dynamic adaptability as traffic requirements, rules, or the topology changes. During the job performance, a direct satellite communication link between two nodes (e.g., between a mobile network node and a NOC) drops out. An SDN controller may learn about the disconnection and may quickly adapt by updating flow entries according to the policies so that traffic may be re-routed through alternative available links to reach the destination.

Thus, flow entries may be correctly implemented and the traffic may be re-shaped according to the QoS profile to accommodate to the lower bandwidth that may be available.

As another scenario, the dropped link may be restored within a certain time. The SDN controller may simply restore the original flow rules back to the switches so that the network continues to route traffic exactly as it did prior to the link unavailability. With the programmability of the controller, the flow rules may be easily reconfigured to route traffic or take different actions, depending on the circumstances or policy rules. Flow rules enable the network to distribute the current load of data traffic to balance over distinctive available paths or alternate full utilization.

As part of setup, upon startup, the SDN controller may establish connection to all switches and push default flow entries out to switches. For example, if a satellite communication link between a mobile network node and a NOC fails due to environmental conditions, involved switches may send notification immediately to the controller. The controller may the re-route data traffic through other nodes to reach the destination. For example, the controller may remove and add flow entries on affected switches. New data traffic may then be relayed through a NOC. For example, the new path may have less bandwidth availability than the path. Therefore, the link may adapt a stricter QOS policy to accommodate the smaller bandwidth availability. The SDN controller may push new flow rules to meet QOS policies to switches.

The SDN controller may continue to monitor the network and manage the network when a formerly dropped satellite communication link restores its connection. Based on demand of each traffic type, load balancing and sharing is feasible between two available links. The flow rules may be configured to transfer all traffic over the restored link immediately or gradually depending on the policies.

In setup, packets may be generated and sent from a first host to a second host through physical ports of the switches. Upon initiation, according to flow rules, flow entries may be populated in the corresponding switch. The flows uploaded on a particular switch may be defined to allow traffic to flow. The packet counter may increment as a flow matches with an incoming packet. For example, ping packets may be generated from host to host. These ping packets are not associated with any ToS (Differentiated Service Code Point (DSCP)) marking and hence they are not traveling through a queue according to the defined action.

When the link between switches drops, the SDN controller may reconfigure the network so that packets are sent out over other available links. Available bandwidth between switches may be significantly less than the dropped link (e.g., link with 20 Mbps). A job planner or network administrator may reconfigure the network so that one or more TOS traffic may be throttled down to enable the network to allow certain high priority traffic to be sent. In this example, they may allow only Type1 and Type2 traffic to go out to the NOC and may discard low priority Type3 traffic. Traffic is routed through available switches accordingly.

When a link connection is restored, it may be unstable and shaky at first. The controller may continue to monitor the link, and once the link becomes stable, other higher priority traffic may be transmitted over the link again. Upon link recovery, only Type3 traffic and some Type2 may be sent over the new link. Type1 and most of Type2 traffic may continue to be sent over a previous 5 Mbps link until the new link is proven to be reliable. For example, a user may write a set of rules to define how the reliability of the link is determined. Also, rules may include types and amount of traffic to be transmitted while the link is under evaluation for reliability.

Existing network devices are capable of achieving similar functionality but resystem is done per device. Also, since the control is located on the actual box, it may be exposed to various attacks. Placing a controller in a secure place may increase the security of network management.

Manually configuring each network device and service for every application is error-prone and time consuming. SDN enables the administration to automate configuring the network and provisioning resources more efficiently and in significantly less time.

The first paper evaluates the feasibility and advantages of a programmable network with FloodLight implementation of OPENFLOW protocol in the example scenario discussed therein. As discussed therein, SDN may provide network automation that enables dynamic policy-based bandwidth and traffic management.

A second use case of SDN, for QoS, is discussed in Dilmaghani et al., “Evaluation of Software-Defined Networking (SDN) for Mission Operations,” 21st ICCRTS Proceedings, 2016 (“second paper” hereinafter).

As discussed in the second paper, a highly reliable, agile, resilient, and secure network infrastructure may be desirable in many environments. Efficient network management, smaller size and lower cost are among other desirable qualities. A communication platform may need to be extensible and scalable to support a myriad of applications with different needs such as data, voice, video, and document sharing.

The second paper discusses how SDN may improve performance by providing prioritized access to certain types of network traffic quickly in bandwidth constrained environments.

For example, as unmanned mobile network nodes may become more ubiquitous in some networks, the need for a robust, secure, and reliable network that dynamically adapts to the network, environmental, or policy changes increases. Policies refer to access policies such as an entity authorized to receive a certain type of traffic from a specific entity or specific QoS policies on the service requirements of a given traffic. Flow rules may be defined at the controller to meet policy requirements. Conventional network systems and settings are mainly static, placing a burden on the network administrator and infrastructure by needing manual device system, with an increased risk of latency and higher risk of human system errors.

It may be desirable to reduce network and resource management complexity, resystem effort, and cost. Interoperability may become even more of a consideration when multiple differing entities are involved, with a variety of devices.

SDN may offer operational advances for many networks, as it enables dynamic and fast response to the circumstances or policy changes in a challenging environment. SDN may dynamically take advantage of multiple paths available to aggregate bandwidth and to meet Quality of Service (QoS). SDN enables manipulating QoS that in turn may lead to control traffic over multiple bearers as they become available. SDN also offers ability to ensure QoS is met as the bandwidth, link quality, and connectivity changes.

As discussed above, SDN separates the data plane from the control plane and renders the network programmable. SDN abstracts the underlying infrastructure for application and network services. SDN enables logical reorganization and the control of the network and mitigates updating traffic flow rules and access control depending on network condition or policies. Orchestration and programmability enables the network to dynamically adapt to the application needs and mitigates the network administrator's effort from mundane and error-prone system settings and enforces consistent security policies across the network. In the second paper, challenges of an example environment in terms of network performance in a Wide Area Network (WAN) environment with high latency and low bandwidth is discussed. An investigation is discussed regarding how using SDN can improve degraded application performance and provide a better service over multiple bearers in a constrained environment by providing levels of assurance and consistency for traffic of a certain priority. SDN automates resystem, and updates traffic forwarding rules to meet QoS for such WAN applications.

As a result of utilizing satellite communication and multiple radio frequency (RF) bearers, many networks may encounter bandwidth constraints and high latency or high bit error rate, which may limit performance. The impact may be exacerbated by the risk of packet fragmentation or by scenarios when security or routing tunnels add headers to the data packet or when, due to network conditions, the number of packet retransmissions is increased.

Bandwidth constraints, latency, loss, transport protocol, and intermittent connectivity may be among significant limitations in a WAN due to discrepancy in bandwidth. There exists a significant difference in speed between LAN and WAN routers. Network latency is a factor that may significantly impact network performance. Adding bandwidth may not improve the network performance when the issue is network latency. Latency reduces network throughput regardless of the available capacity. Delay variation (e.g., jitter) may impact the performance of some applications such as video streaming. Environmental conditions or interference may impact data loss and the rate of retransmission.

In such dynamic environments, automating QoS and access policies may reduce the amount of effort needed for device resystem and for troubleshooting as the probability of human error is reduced. The flow rules may be set to ensure that job critical applications requirements are met. SDN may aid in automating resystem by adapting to network or policy changes with a logically central controller and global view of the network.

QoS defines the level of the service the applications receive, which defines how a traffic type receives bandwidth, delay, or loss. QoS provides preferred service to certain types of network traffic over other types. Many WAN applications may differ in the QoS requirements. Three different types of example applications are discussed in the second paper. For example, real-time applications such as voice and video may need reserved bandwidth and may be very sensitive to delay and jitter. Interactive applications (second type) may need prioritization. Routine applications are the third type. Examples of prioritized applications are chat and job-critical applications to create collaboration and job-related emails. Finally, the last category, routine applications, are those that are most tolerant to delay and are not job critical such as personal email. The Floodlight implementation of the OPENFLOW protocol is used for discussion by the second paper.

In an example scenario in the second paper, three mobile network nodes are part of a job that involves sharing information for the network and continues forwarding as the network and environmental condition changes. The three mobile network nodes want to share critical information with each other and with other members of the job. The data needs to be forwarded from a first mobile network node to a first location, going through the Network Operation Center (NOC) before reaching the destination, and to be sent directly over Line of Sight (LoS) to another mobile network node when available. As the environmental conditions change, there may be a connectivity disruption on the initial path. Similarly, access policies may change which needs an entity or a route to be excluded from the communication path, which involves updates to the policies.

In a scenario discussed in the second paper, a differentiated QoS is used, defining three types of traffic priority: Type1 represents the highest priority and Type3 represents the lowest priority. Differentiated services or DiffSery uses IP ToS bytes to mark the class. The DSCP value and the corresponding Type of Service (ToS) is defined. Packets may be generated with a multi-generator to represent different types of traffic for QoS. One flow of TCP and three flows of User Datagram Protocol (UDP) traffic may be generated at a mobile network node. Each flow may be sent to a given port upon initiation. Data types 1, 2, and 3 may be generated at the rates of 5 Mbps, 3 Mbps, and 2 Mbps, respectively.

The appropriate type of service may be defined based on existing conditions of the network, its capabilities to support application specific needs, the relevance and urgency of the application to the job, and continuous operation and maintenance of the service.

In experimentation discussed by the second paper, QoS system is implemented by the user and is defined outside OPENFLOW protocol, either via command line or through an external protocol. Queues are attached to ports and they enable policies such as rate limiting on a multi-path routing. Different paths have different size of pipes depending on the link capacity. For the experimentation of the second paper, multiple queues are defined to handle a user-defined data traffic type.

The controller monitors the switches and the links for any topology change in the network. The controller is programmed such that it can update flow entries depending on the environment or job condition. The controller injects flow entries to each WAN switch to meet QoS to forward the traffic through the alternative paths to the destination. To respond to a change in the link or network, policies, or the environment, a flow is added to the table that forwards the traffic in accordance with the service requirements and new conditions.

The network topology includes five Wide Area Network (WAN) switches, three mobile network nodes and 2 NOCs, in which large volumes of data and voice are transferred over WAN links. Mobile network node switches are connected to the NOC via a satellite link. A network node to network node communication is possible, depending on distance and network conditions when a LoS exists.

The initial satellite communication path has sufficient bandwidth to transmit data via a NOC to a first mobile network node. The satellite communication link between a second mobile network node and the NOC may fail. The SDN controller continues to monitor the network and learns about the disconnection and quickly adapts the forwarding rules by updating flow entries according to the policies and existing paths so that traffic is re-routed through alternative links available to reach the first mobile network node. Traffic now is forwarded over satellite communication through another NOC and through the LoS to the first mobile network node. For this example, QoS is adjusted for different data rates available over alternate paths. The capacity of the initial link is 10 Mbps and after the failure, there is a bandwidth limitation which involves sending the same amount of data over two paths, with capacities of 6 Mbps and 2 Mbps. The requirements may be adjusted by an administrator one time which saves the administrator's time and reduces probability error of resystem per box. The updated flow rules allow type 1 traffic to be sent over satellite communication with no delay. Type 2 is sent over the two available LoSs. Traffic type 3, which has the lowest priority, experiences latency as only half of the bandwidth requirement is available for transmission over the alternate path.

The original link is later restored, and the SDN controller restores a part of the original flows to the recovered link, and after another user-defined reliability measure is satisfied, returns all traffic types back to an initial state. The flow rules may be configured to transfer all traffic over the restored link immediately or gradually depending on the policies and pre-defined criteria. Thus, SDN may aid with automated resystem to meet the needs of different types of traffic depending on the link availabilities.

Using the SDN controller's programmable interface, the flow rules are automatically reconfigured to forward traffic through alternate paths. It is also possible to define alternate actions depending on the circumstances or policy rules. Flow rules determine where and how to forward the traffic over available paths.

Example aspects discussed herein may be implemented as a series of modules, either functioning alone or in concert with physical electronic and computer hardware devices. Example methods discussed herein may be implemented as a program product comprising a plurality of such modules, which may be displayed for a user. As used herein, the term “module” generally refers to a software module. A module may be implemented as a collection of routines and data structures that performs particular tasks or implements a particular abstract data type. Modules generally are composed of two parts. First, a software module may list the constants, data types, variables, and routines that may be accessed by other modules or routines. Second, a module may be configured as an implementation, which may be private (i.e., accessible only to the module), and which contains the source code that actually implements the routines or subroutines upon which the module is based. Such modules may be utilized separately and/or together locally and/or remotely to form a program product thereof, that may be implemented through non-transitory machine readable recordable media.

Various storage media, such as magnetic computer disks, optical disks, and electronic memories, as well as non-transitory computer-readable storage media and computer program products, can be prepared that can contain information that can direct a device, such as a micro-controller, to implement the above-described systems and/or methods. Once an appropriate device has access to the information and programs contained on the storage media, the storage media can provide the information and programs to the device, enabling the device to perform the above-described systems and/or methods.

For example, if a computer disk containing appropriate materials, such as a source file, an object file, or an executable file, were provided to a computer, the computer could receive the information, appropriately configure itself and perform the functions of the various systems and methods outlined in the diagrams and flowcharts above to implement the various functions. That is, the computer could receive various portions of information from the disk relating to different elements of the above-described systems and/or methods, implement the individual systems and/or methods, and coordinate the functions of the individual systems and/or methods.

Features discussed herein are provided as example methods that may be implemented in many different ways that may be understood by one of skill in the art of computing, without departing from the discussion herein. Such features are to be construed only as example features, and are not intended to be construed as limiting to only those detailed descriptions.

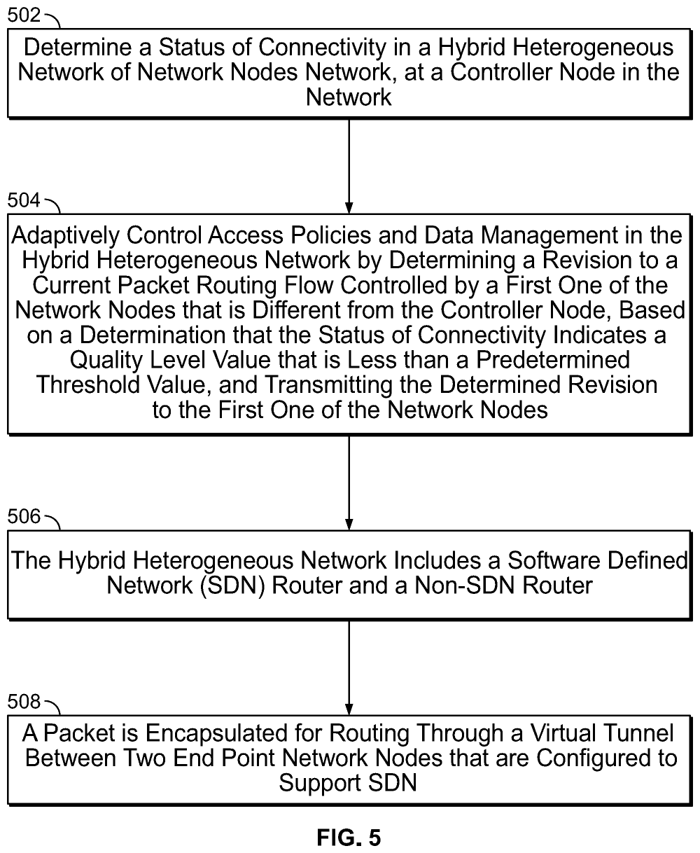

FIG. 5 is a flowchart illustrating example operations of the system of FIG. 4, according to example embodiments. As shown in the example of FIG. 5, a status of connectivity in a hybrid heterogeneous network of network nodes is determined, at a controller node in the network (502). Access policies and data management in the hybrid heterogeneous network are adaptively controlled by determining a revision to a current packet routing flow controlled by a first one of the network nodes that is different from the controller node, based on a determination that the status of connectivity indicates a quality level value that is less than a predetermined threshold value, and transmitting the determined revision to the first one of the network nodes (504). The hybrid heterogeneous network includes a Software Defined Network (SDN) router and a non-SDN router (506). A packet is encapsulated for routing through a virtual tunnel between two end point network nodes that are configured to support SDN (508).

For example, determining the revision to the current packet routing flow includes determining a revision to a flow table entry of a flow table in the first one of the network nodes, and transmitting the determined revision includes transmitting the revision to the flow table entry to the first one of the network nodes.

For example, the status of connectivity in the network indicates a dropped connection associated with connecting the first one of the network nodes to a second one of the network nodes.

For example, the status of connectivity in the network indicates a connection that is currently not in compliance with a Quality of Service (QoS) value.

For example, the hybrid heterogeneous network includes at least one of the network nodes that supports a Software Defined Network (SDN) protocol and an Internet Protocol (IP).

For example, the hybrid heterogeneous network includes a plurality of mobile network nodes.

For example, the controller node includes a device that utilizes an OPENFLOW communication protocol.

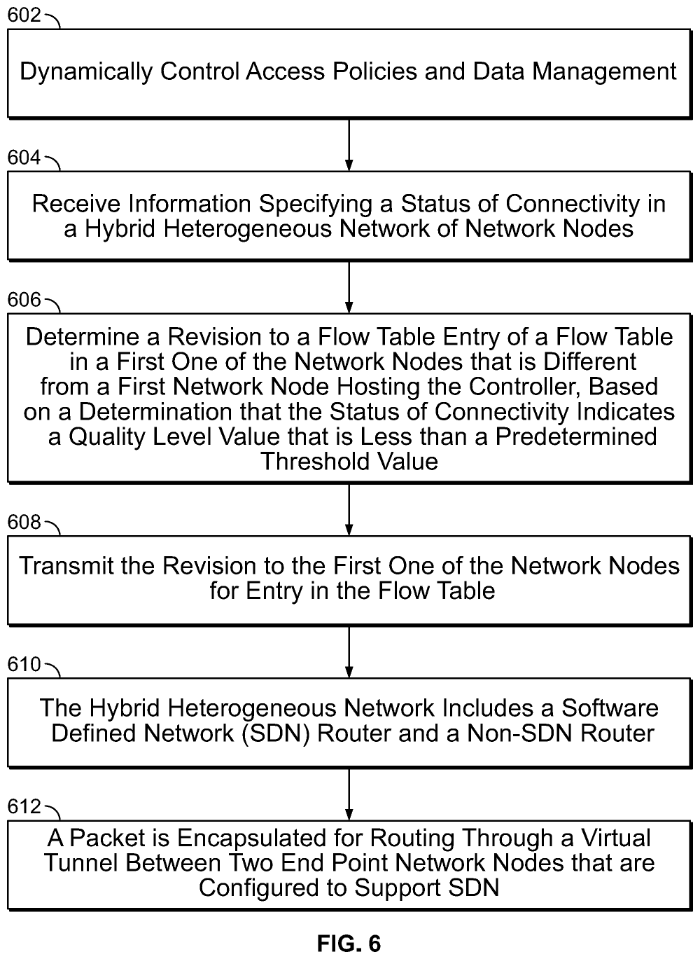

FIG. 6 is a flowchart illustrating example operations of the system of FIG. 4, according to example embodiments. As shown in the example of FIG. 6, a controller that dynamically controls access policies and data management are dynamically controlled by a controller (602).

Information specifying a status of connectivity in a hybrid heterogeneous network of network nodes is received (604).

A revision to a flow table entry of a flow table in a first one of the network nodes that is different from a first network node hosting the controller may be determined, based on a determination that the status of connectivity indicates a quality level value that is less than a predetermined threshold value (606).

The revision may be transmitted to the first one of the network nodes for entry in the flow table (608).

The hybrid heterogeneous network includes a Software Defined Network (SDN) router and a non-SDN router (610). A packet is encapsulated for routing through a virtual tunnel between two end point network nodes that are configured to support SDN (612).

For example, the controller utilizes an OPENFLOW communication protocol.

For example, the status of connectivity in the hybrid heterogeneous network indicates a dropped connection associated with connecting the first one of the network nodes to a second one of the network nodes.

For example, the status of connectivity in the hybrid heterogeneous network indicates a connection that is currently not in compliance with a Quality of Service (QoS) value.

For example, the hybrid heterogeneous network includes at least one of the network nodes that supports a Software Defined Network (SDN) protocol and an Internet Protocol (IP).

For example, the hybrid heterogeneous network includes a plurality of mobile network nodes.

One skilled in the art of computing will appreciate that many other types of methods may be used for concepts discussed herein, without departing from the discussion herein.

Features discussed herein are provided as example methods that may be implemented in many different ways that may be understood by one of skill in the art of computing, without departing from the discussion herein. Such features are to be construed only as example features, and are not intended to be construed as limiting to only those detailed descriptions.

For example, the one or more processors (e.g., hardware processors) may be included in at least one processing apparatus. One skilled in the art of computing will understand that there are many systems of processors and processing apparatuses that may be configured in accordance with the discussion herein, without departing from such discussion.

In this context, a “component” or “module” may refer to instructions or hardware that may be configured to perform certain operations. Such instructions may be included within component groups of instructions, or may be distributed over more than one group. For example, some instructions associated with operations of a first component may be included in a group of instructions associated with operations of a second component (or more components). For example, a “component” herein may refer to a type of functionality that may be implemented by instructions that may be located in a single entity, or may be spread or distributed over multiple entities, and may overlap with instructions and/or hardware associated with other components.

In this context, a “memory” may include a single memory device or multiple memory devices configured to store data and/or instructions. Further, the memory may span multiple distributed storage devices. Further, the memory may be distributed among a plurality of processors.

One skilled in the art of computing will understand that there may be many ways of accomplishing the features discussed herein.

It will be understood that many additional changes in the details, materials, steps and arrangement of parts, which have been herein described and illustrated to explain the nature of the invention, may be made by those skilled in the art within the principle and scope of the invention as expressed in the appended claims.

What is claimed is:

1. A method comprising:
determining, at a controller node in a hybrid heterogeneous network of network nodes, a status of connectivity in the network; and
adaptively controlling access policies and data management in the hybrid heterogeneous network by:
determining a revision to a current packet routing flow controlled by a first one of the network nodes that is different from the controller node, based on a determination that the status of connectivity indicates a quality level value that is less than a predetermined threshold value; and
transmitting the determined revision to the first one of the network nodes,
wherein the hybrid heterogeneous network includes a Software Defined Network (SDN) router and a non-SDN router,
wherein a packet is encapsulated for routing through a virtual tunnel between two end point network nodes that are configured to support SDN.

2. The method of claim 1, wherein:
determining the revision to the current packet routing flow includes determining a revision to a flow table entry of a flow table in the first one of the network nodes, and
transmitting the determined revision includes transmitting the revision to the flow table entry to the first one of the network nodes.

3. The method of claim 1, wherein:
the status of connectivity in the network indicates a dropped connection associated with connecting the first one of the network nodes to a second one of the network nodes.

4. The method of claim 1, wherein:
the status of connectivity in the network indicates a connection that is currently not in compliance with a Quality of Service (QoS) value.

5. The method of claim 1, wherein:
the hybrid heterogeneous network includes at least one of the network nodes that supports a Software Defined Network (SDN) protocol and an Internet Protocol (IP).

6. The method of claim 1, wherein the hybrid heterogeneous network includes a plurality of mobile network nodes.

7. The method of claim 1, wherein the controller node includes a device that utilizes an OPENFLOW communication protocol.

8. A system comprising:
at least one hardware device processor; and
a controller that dynamically controls access policies and data management by:
receiving information specifying a status of connectivity in a hybrid heterogeneous network of network nodes;
determining a revision to a flow table entry of a flow table in a first one of the network nodes that is different from a first network node hosting the controller, based on a determination that the status of connectivity indicates a quality level value that is less than a predetermined threshold value;
transmitting the revision to the first one of the network nodes for entry in the flow table,
wherein the hybrid heterogeneous network includes a Software Defined Network (SDN) router and a non-SDN router,
wherein a packet is encapsulated for routing through a virtual tunnel between two end point network nodes that are configured to support SDN.

9. The system of claim 8, wherein the controller utilizes an OPENFLOW communication protocol.

10. The system of claim 8, wherein:
the status of connectivity in the hybrid heterogeneous network indicates a dropped connection associated with connecting the first one of the network nodes to a second one of the network nodes.

11. The system of claim 8, wherein:
the status of connectivity in the hybrid heterogeneous network indicates a connection that is currently not in compliance with a Quality of Service (QoS) value.

12. The system of claim 8, wherein:
the hybrid heterogeneous network includes at least one of the network nodes that supports a Software Defined Network (SDN) protocol and an Internet Protocol (IP).

13. The system of claim 8, wherein the hybrid heterogeneous network includes a plurality of mobile network nodes.

14. A non-transitory computer-readable storage medium storing instructions that are executable by a device processor to:
determine, at a controller node in a hybrid heterogeneous network of network nodes, a status of connectivity in the network; and
adaptively control access policies and data management in the hybrid heterogeneous network by:
determining a revision to a current packet routing flow controlled by a first one of the network nodes that is different from the controller node, based on a determination that the status of connectivity indicates a quality level value that is less than a predetermined threshold value; and
transmitting the determined revision to the first one of the network nodes,
wherein the hybrid heterogeneous network includes a Software Defined Network (SDN) router and a non-SDN router,
wherein a packet is encapsulated for routing through a virtual tunnel between two end point network nodes that are configured to support SDN.

15. The non-transitory computer-readable storage medium of claim 14, wherein:
determining the revision to the current packet routing flow includes determining a revision to a flow table entry of a flow table in the first one of the network nodes, and
transmitting the determined revision includes transmitting the revision to the flow table entry to the first one of the network nodes.

16. The non-transitory computer-readable storage medium of claim 14, wherein:
the status of connectivity in the network indicates a dropped connection associated with connecting the first one of the network nodes to a second one of the network nodes.

17. The non-transitory computer-readable storage medium of claim 14, wherein:
the status of connectivity in the network indicates a connection that is currently not in compliance with a Quality of Service (QoS) value.

18. The non-transitory computer-readable storage medium of claim 14, wherein:
the hybrid heterogeneous network includes at least one of the network nodes that supports a Software Defined Network (SDN) protocol and an Internet Protocol (IP).

19. The non-transitory computer-readable storage medium of claim 14, wherein the hybrid heterogeneous network includes a plurality of mobile network nodes.

20. The non-transitory computer-readable storage medium of claim 14, wherein the controller node includes a device that utilizes an OPENFLOW communication protocol.
